(19) United States
(12) Patent Application Publication
(10) Pub. No.: US 2009/0297238 A1
(43) Pub. Date: Dec. 3, 2009

(54) BRUSH ROLLER, IMAGE FORMING APPARATUS, AND PROCESS CARTRIDGE

(76) Inventors: Hiroki Matsuura, Kanagawa (JP); Shinichi Kawahara, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/466,568

(22) Filed: May 15, 2009

(30) Foreign Application Priority Data
May 30, 2008 (JP) 2008-141999

(51) Int. Cl. G03G 21/00

(52) U.S. Cl. 399/346

(57) ABSTRACT

An image forming apparatus includes an image carrier on which a toner image is formed; a cleaning unit that removes residual toner remaining on the image carrier after transferring the toner image onto a medium; and a lubricant applying unit that includes a lubricant and a brush roller that scrapes the lubricant and applies scraped lubricant to the image carrier and that is arranged upstream of the cleaning unit in a rotation direction of the image carrier. The brush roller includes a bristle of which cross section is shaped such that a point from which a plurality of projections extends is positioned outside a center of the cross section of the bristle.

### CROSS-REFERENCE TO RELATED APPLICATIONS

The present application claims priority to and incorporates by reference the entire contents of Japanese priority document 2008-141999 filed in Japan on May 30, 2008.

### BACKGROUND OF THE INVENTION

1. Field of the Invention

The present invention relates to a technology for applying a lubricant to an image carrier in an image forming apparatus.

2. Description of the Related Art

Recently, a color image forming apparatus that employs an electrophotographic method is becoming popular while digitalized image data is becoming more easily available. Accordingly, demands for forming high-definition images of the digitalized image data by the image forming apparatus are growing. To fulfill this demand, resolution and tone reproducibility of images are being improved. With regard to toner used for developing latent images, the toner containing more fine and spherical particles (hereinafter, referred to as “fine and spherical toner”) are being developed to form the high-definition images.

More particularly, technologies for producing the fine and spherical toner are disclosed as follows. A crushing method for producing toner that contains spherical particles with a predetermined particle-diameter distribution is disclosed in, for example, Japanese Patent Application Laid-open No. H1-112253, Japanese Patent Application Laid-open No. H2-284158, Japanese Patent Application Laid-open No. H3-181952, and Japanese Patent Application Laid-open No. H4-162048. Furthermore, Japanese Patent Application Laid-open No. H5-72808 discloses a suspension polymerization method for producing finer and more spherical toner. Moreover, Japanese Patent Application Laid-open No. H9-15902 discloses a technology for producing the fine and spherical toner by mixing binder resin and colorant in water-nonmiscible solvent, and dispersing the mixture in aqueous solvent containing dispersion stabilizer. Furthermore, Japanese Patent Application Laid-open No. H11-133668 discloses a technology for producing the fine and spherical toner by mixing binder resin containing denatured resin and colorant in organic solvent, and dispersing the mixture in aqueous solvent so that polyaddition reaction of the denatured resin is induced. With the fine and spherical toner produced by the above methods, image quality and toner flowability can be improved.

Because the fine and spherical toner can be transferred assuredly, it is preferably used for forming high-definition images. However, the fine and spherical toner is easy to slide on a photosensitive element, so that some toner may remain on the photosensitive element during cleaning by a cleaning blade of a cleaning unit. As a result, cleaning failure occurs, resulting in degradation of images such as occurrence of background defect in the images.

To address the above problem, Japanese Patent Application Laid-open No. H11-184340 discloses an image forming apparatus employing an electrophotographic method, which includes a cleaning unit that removes toner remaining on a photosensitive element after transferring an image onto a recording medium with an elastic rubber blade and in which the elastic rubber blade is fixed to the cleaning unit via a supporting member on the side where the blade comes into contact with the photosensitive element. Zinc stearate is added as a lubricant to the toner such that zinc-stearate content is in a range from 0.01 percent to 0.5 percent by weight with respect to the toner. With this technology, when an image with a large image area is formed, a large amount of toner is applied to the photosensitive element, so that a sufficient amount of the zinc stearate can be applied to the photosensitive element. However, when an image with a small image area is formed, only a small amount of toner is applied to the photosensitive element, so that a sufficient amount of zinc stearate cannot be applied to the photosensitive element. Thus, the amount of the lubricant to be applied to the photosensitive element varies depending on an image to be developed, which is problematic.

Japanese Patent Application Laid-open No. 2004-333961 discloses a technology for arranging an applying unit that applies a lubricant to an image carrier on which a latent image is formed in an image forming apparatus. The image forming apparatus includes the image carrier, a charging unit that causes a charging member to come into contact or close contact with the surface of the image carrier to charge the image carrier, a latent-image forming unit that forms a latent image on the image carrier, a developing unit that develops the latent image on the image carrier with toner, a transferring unit that transfers a toner image formed on the image carrier onto a recording medium carried by a surface moving unit or the surface moving unit itself by forming a transfer electric field between the image carrier and the surface moving unit that moves while being in contact with the image carrier, and a cleaning unit that causes a cleaning blade to remove residual toner remained on the image carrier. The applying unit is formed of a brush roller that scrapes a molded solid lubricant and applies scraped portion of the lubricant to the image carrier. The brush roller is caused to eat into the lubricant by a pressing unit, such as a spring, so that the brush roller can scrape the surface of the lubricant and apply the scraped portion of the lubricant to the image carrier while rotating.

When the amount by which the brush roller eats into the lubricant (hereinafter, “eaten amount”) is increased by increasing the pressing force of the lubricant towards the brush roller, the amount of the lubricant to be applied to the image carrier can be increased, so that cleaning of the photosensitive element can be performed more stably. However, as the eaten amount increases, rotational load on the brush roller increases, leading to problems such as shortening of life of the brush roller, increase in costs due to increase in torque of a motor, increase in consumption power, or occurrence of banding due to rotational oscillation of the brush roller.

To assure a cleaning performance, it is necessary to apply a sufficient amount of lubricant to the image carrier. However, attempts in the conventional technologies lead to the above problems.

### SUMMARY OF THE INVENTION

It is an object of the present invention to at least partially solve the problems in the conventional technology.

According to one aspect of the present invention, there is provided a brush roller that scrapes a lubricant and applies scraped lubricant to an image carrier. The brush roller includes a bristle of which cross section is shaped such that a point from which a plurality of projections extends is positioned outside a center of the cross section of the bristle.

Moreover, according to another aspect of the present invention, there is provided an image forming apparatus including an image carrier on which a toner image is formed; a cleaning unit that removes residual toner remaining on the image carrier after transferring the toner image on the image carrier onto a medium; and a lubricant applying unit that includes a lubricant and a brush roller that scrapes the lubricant and applies scraped lubricant to the image carrier, and that is arranged upstream of the cleaning unit in a rotation direction of the image carrier. The brush roller includes a bristle of which a cross section is shaped such that a point from which a plurality of projections extends is positioned outside a center of the cross section of the bristle.

Furthermore, according to still another aspect of the present invention, there is provided a process cartridge that is detachable from an image forming apparatus. The process cartridge includes an image carrier on which a latent image is formed; at least one of a charging unit that charges the image carrier, a developing unit that develops the latent image on the image carrier into a toner image with toner, and a cleaning unit that removes residual toner remaining on the image carrier after transferring the toner image on the image carrier onto a medium; and a lubricant applying unit that includes a lubricant and a brush roller that scrapes the lubricant and applies scraped lubricant to the image carrier, and that is arranged upstream of the cleaning unit in a rotation direction of the image carrier.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus that is a compact full-color printer according to an embodiment of the present invention;

FIG. 2 is a schematic diagram of an image forming unit in the image forming apparatus shown in FIG. 1;

FIG. 3 is a schematic diagram for explaining a method of measuring a coefficient of friction of a photosensitive element of the image forming unit shown in FIG. 2;

FIG. 4A is a schematic diagram of examples of cross sections of a bristle of a conventional brush roller; and

FIG. 4B is a schematic diagram of examples of cross sections of a bristle of a brush roller according to the embodiment.

### DETAILED DESCRIPTION OF THE PREFERRED EMBODIMENTS

Exemplary embodiments of the present invention are explained in detail below with reference to the accompanying drawings. Various modifications that can be easily made by a person skilled in the art within the scope of the present invention are considered to be included in the present invention. The following embodiments are merely preferable examples, so that the present invention is not limited to the embodiments described below.

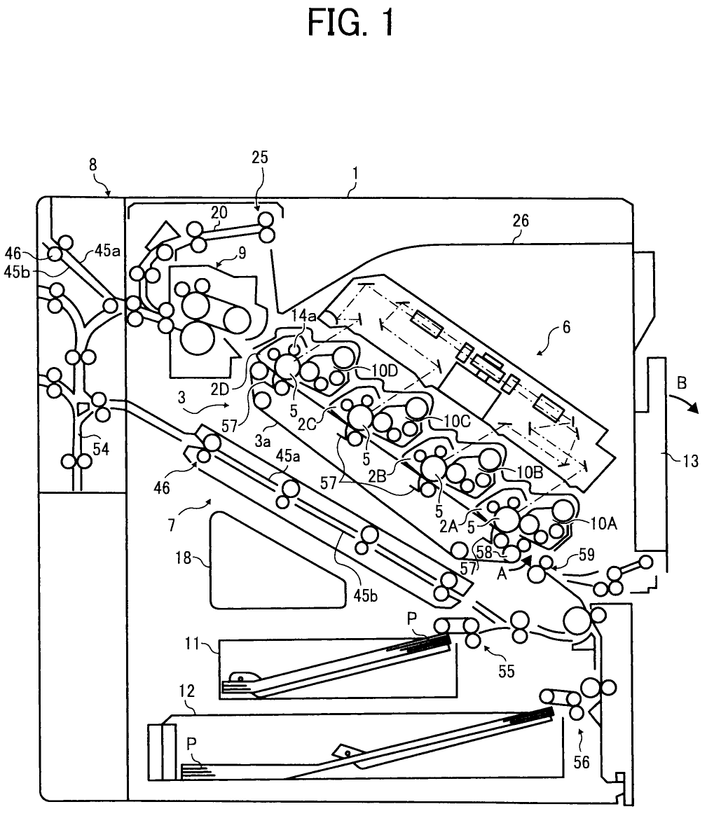

FIG. 1 is a schematic diagram of an image forming apparatus that is a compact full-color printer according to an embodiment of the present invention. In a body 1 of the image forming apparatus (hereinafter, “an apparatus body 1”), image forming units 2A, 2B, 2C, and 2D are arranged such that they can be removed as appropriate from the apparatus body 1 (hereinafter, the image forming units 2A, 2B, 2C, and 2D are collectively referred to as “an image forming unit 2” as appropriate). Each of the image forming units 2A, 2B, 2C, and 2D includes a drum-shaped photosensitive element 5 that serves as an image carrier. A transfer unit 3 that includes an intermediate transfer belt 3a is arranged in the substantially center area of the apparatus body 1. The intermediate transfer belt 3a is supported by a plurality of rollers to be rotatable in a direction indicated by an arrow A in FIG. 1.

The photosensitive elements 5 of the respective image forming units 2A, 2B, 2C, and 2D are arranged to be brought into contact with the upper surface of the intermediate transfer belt 3a. Developing units 10A, 10B, 10C, and 10D that develop images with toner of different colors are arranged to correspond to the image forming units 2A, 2B, 2C, and 2D, respectively.

The image forming units 2A, 2B, 2C, and 2D have the same configuration except for the color of toner to be used. Specifically, the image forming unit 2A forms a magenta image, the image forming unit 2B forms a cyan image, the image forming unit 2C forms a yellow image, and the image forming unit 2D forms a black image.

A writing unit 6 is arranged above the image forming units 2A, 2B, 2C, and 2D. A double siding unit 7 is arranged below the intermediate transfer belt 3a. A reversing unit 8 is attached to the left side of the apparatus body 1 in FIG. 1. The reversing unit 8 reverses a printing sheet P, and discharges the reversed printing sheet P out of the image forming apparatus or conveys the reversed printing sheet P to the double siding unit 7.

The writing unit 6 includes, although not shown, four light sources that are laser diodes (LD) for four different colors, a set of polygon scanner including a six-sided polygon mirror and a motor, fθ lenses arranged on optical paths of the respective light sources, a lens such as a long cylindrical lens, and a mirror. Laser light emitted from each of the LDs is deflected for scanning by the polygon scanner, so that each of the photosensitive elements 5 is irradiated with the laser light.

The double siding unit 7 includes a pair of a conveying guide plate 45a and a conveying guide plate 45b, and a plurality of pairs of conveying rollers 46 (in this example, four pairs). In a double-sided image forming mode in which an image is formed on both sides of the printing sheet P, the printing sheet P having an image on one side thereof is conveyed to a reverse conveying path 54 in the reversing unit 8 to be reversed. Then, the double siding unit 7 receives the printing sheet P and conveys it towards a sheet feeding unit.

The reversing unit 8 includes a plurality of pairs of the conveying rollers 46 and a pair of the conveying guide plates 45a and 45b. As described above, the reversing unit 8 reverses the printing sheet P and then conveys the reversed printing sheet P to the double siding unit 7 for forming an image on both sides of the printing sheet P, discharges the printing sheet P out of the image forming apparatus without reversing the printing sheet P, or discharges the printing sheet P out of the image forming apparatus after reversing the printing sheet P. The sheet feeding unit includes a sheet cassette 11, a sheet cassette 12, a separated-sheet feeding unit 55 arranged for the sheet cassette 11, and a separated-sheet feeding unit 56 arranged for the sheet cassette 12. The separated-sheet feeding units 55 and 56 separate and feed one printing sheet P from the printing sheets P stacked in the sheet cassettes 11 and 12.

A fixing unit 9 that fixes transferred images onto the printing sheet P is arranged between the intermediate transfer belt 3a and the reversing unit 8. A reverse discharge path 20 is branched on the downstream side of the fixing unit 9 in a printing-sheet conveying direction, so that the printing sheet P conveyed to the reverse discharge path 20 can be discharged on a catch tray 26 by a pair of discharge rollers 25.

The sheet cassettes 11 and 12 in which printing sheets P of different sizes can be stacked, respectively, are arranged in two stages in the bottom area of the apparatus body 1. A bypass tray 13 is attached to the right side of the apparatus body such that the bypass tray 13 can be opened in a direction indicated by an arrow B shown in FIG. 1. When the bypass tray 13 is opened, sheets can be manually fed from the bypass tray 13 into the apparatus body 1.

An image forming operation performed by the image forming apparatus is described below. When the image forming operation is started, the photosensitive elements 5 start rotating clockwise in FIG. 1. Charging rollers 14a uniformly charge the surfaces of the photosensitive elements 5, respectively. Then, the writing unit 6 irradiate the photosensitive elements 5 in the image forming units 2A, 2B, 2C, and 2D with laser light corresponding to magenta, cyan, yellow, and black images, respectively. As a result, latent images of corresponding colors are formed on the photosensitive elements 5, respectively. When the latent images are conveyed to positions corresponding to the developing units 10A, 10B, 10C, and 10D along with rotation of the photosensitive elements 5, respectively, the latent images are developed with toner of corresponding colors of magenta, cyan, yellow, and black, so that four toner images are formed. At this time, a lubricant added to the toner is also applied to the surfaces of the photosensitive elements 5.

The printing sheet P fed by the separated-sheet feeding unit 55 or the separated-sheet feeding unit 56 from the sheet cassette 11 or the sheet cassette 12 is further conveyed by a pair of registration rollers 59 that is arranged just upstream of the intermediate transfer belt 3a in the printing-sheet conveying direction at a timing corresponding to a timing of conveying the toner images on the photosensitive elements 5. The printing sheet P is charged to a positive polarity by a sheet attracting roller 58 arranged near an entrance of the intermediate transfer belt 3a, so that the printing sheet P is electrostatically attracted to the surface of the intermediate transfer belt 3a. The printing sheet P is then conveyed while being attracted to the intermediate transfer belt 3a, so that the toner images of magenta, cyan, yellow, and black are sequentially transferred onto the printing sheet P in a superimposed manner. As a result, a full-color toner image is formed on the printing sheet P. At this time, the lubricant added to the toner is also transferred onto the printing sheet P, while some toner remains on the photosensitive elements 5 without being transferred onto the printing sheet P. The printing sheet P is then conveyed to the fixing unit 9. The fixing unit 9 applies heat and pressure to the printing sheet P, so that the full-color toner image melts and is fixed to the printing sheet P. Then, the printing sheet P is conveyed through a discharge path corresponding to a specified mode. Specifically, the printing sheet P is reversed and then discharged on the catch tray 26 arranged on a top portion of the apparatus body 1, the printing sheet P is directly discharged from the fixing unit 9 through the reversing unit 8, or the printing sheet P is conveyed to the reverse conveying path 54 in the reversing unit 8 to guide the printing sheet P to the double siding unit 7 when the double-sided image forming mode is selected. The printing sheet P guided to the double siding unit 7 is further conveyed to an image forming area including the image forming units 2A, 2B, 2C, and 2D, so that an image can be formed on the back side of the printing sheet P. Subsequently, the printing sheet P is discharged out of the image forming apparatus.

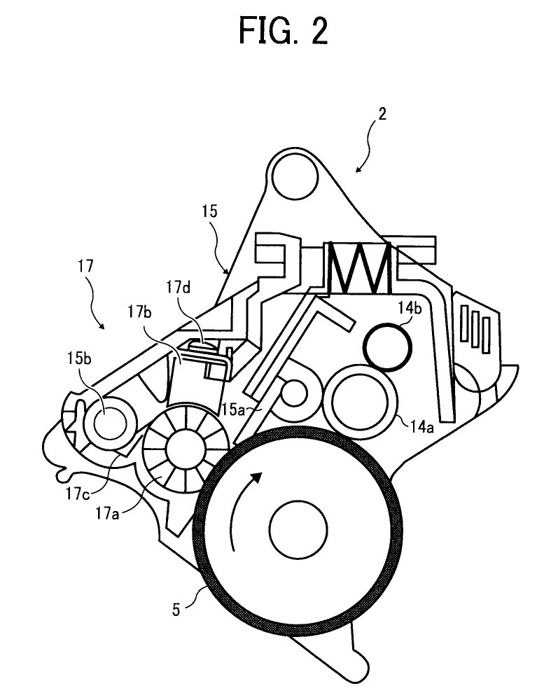

The photosensitive element 5 is separated from the intermediate transfer belt 3a and keeps rotating, and a brush roller 17a applies lubricant scraped from a solid lubricant 17b (see FIG. 2) to the photosensitive element 5. At this time, residual toner that has not been transferred onto the printing sheet P remains on the photosensitive element 5. On the surface of the residual toner, lubricant that has been added is remained. When a cleaning blade 15a (see FIG. 2) scrapes off the residual toner to clean the photosensitive element 5, the residual toner is pressed towards the photosensitive element 5, so that the lubricant is applied from the residual toner to the surface of the photosensitive element 5. As a result, coating is formed on the photosensitive element 5. At the same time, the lubricant applied to the photosensitive element 5 by the brush roller 17a is also pressed towards the photosensitive element 5, so that the surface of the photosensitive element 5 is also coated with the lubricant applied by the brush roller 17a.

The coating of the lubricant on the photosensitive element 5 is so thin that charging by charging units 14 is not disturbed when the above image forming process is repeated for forming a subsequent image. Thereafter, toner images re-developed on the photosensitive elements 5 are transferred onto the printing sheet P being attracted to the intermediate transfer belt 3a.

Each of the developing units 10A, 10B, 10C, and 10D includes, although not shown, a developing roller opposing a corresponding one of the photosensitive elements 5, a screw that feeds and agitates developer (toner), and a toner density sensor. The developing roller includes a magnet (not shown) and a sleeve (not shown) rotatably arranged thereon. A toner supplying unit (not shown) supplies toner based on an output signal from the toner density sensor. In the present embodiment, two-component developer containing toner and carrier is used as the developer.

The carrier is generally formed of a core material only or a core material coated with a coating layer. Ferrite or magnetite can be used as the core material of a resin-coated carrier that is applicable in the present embodiment. The diameter of the core material is preferably set to be in a range from about 20 micrometers (μm) to 65 μm, and more preferably set to be in a range from about 30 μm to 60 μm. The coating layer of the carrier can be made of resin, such as polystyrene, acrylic resin, fluorine resin, or silicone resin, mixture of the above resin, or copolymer of the above resin. The coating layer can be formed by applying resin to the surface of the core material of the carrier by using a known method such as a spraying method or a dipping method.

FIG. 2 is a schematic diagram of the image forming unit 2. The image forming unit 2 includes the charging roller 14a, the photosensitive element 5 on which an electrostatic latent image is formed, a cleaning unit 15 including the cleaning blade 15a that cleans the surface of the photosensitive element 5, and an applying unit 17 including the brush roller 17a that applies the lubricant to the photosensitive element 5. The charging roller 14a is either conductive or semi-conductive, and applies direct-current voltage or/and alternating-current voltage to the photosensitive element 5, so that the photosensitive element 5 is charged with electric charge. A charging-roller cleaning brush 14b that cleans the surface of the charging roller 14a is brought into contact with the charging roller 14a. In the cleaning unit 15, the brush roller 17a conveys residual toner scraped off by the cleaning blade 15a towards a toner-conveying auger 15b, and the residual toner collected at the toner-conveying auger 15b is conveyed to a residual toner container 18 shown in FIG. 1 by rotating the toner-conveying auger 15b.

The applying unit 17 is incorporated in a body of the image forming unit 2. The applying unit 17 includes the solid lubricant 17b, the brush roller 17a that comes into contact with the solid lubricant 17b and scrapes the solid lubricant 17b and applies the scraped portion of the solid lubricant 17b to the surface of the photosensitive element 5, a scraper 17c that removes toner adhering to the brush roller 17a, and a spring 17d that presses the solid lubricant 17b towards the brush roller 17a by a predetermined pressing force. The solid lubricant 17b is shaped into a rectangular parallelepiped. The brush roller 17a is extended in an axial direction of the photosensitive element 5. The spring 17d is biased towards the brush roller 17a so that the solid lubricant 17b can be consumed completely. While the thickness of the solid lubricant 17b decreases over time as the solid lubricant 17b is consumed, the solid lubricant 17b can always be brought into contact with the brush roller 17a due to the pressure by the spring 17d. Accordingly, the brush roller 17a can scrape the solid lubricant 17b and apply the scraped portion of the solid lubricant 17b to the photosensitive element 5. In the present embodiment, it is assumed that the photosensitive element serves as an image carrier; however, a transfer belt can be employed as the image carrier.

Returning to FIG. 1, the developing units 10A, 10B, 10C, and 10D, each of which develops a latent image with a two-component developer, have the same configuration except for the color of the toner to be used. Specifically, the developing units 10A, 10B, 10C, and 10D develop latent images with magenta toner, cyan toner, yellow toner, and black toner, respectively. Each of the developing units 10A, 10B, 10C, and 10D accommodates developer containing toner and carrier.

The solid lubricant 17b can be made of, for example, metal salts of fatty acids such as lead oleate, zinc oleate, copper oleate, zinc stearate, cobalt stearate, ferric stearate, copper stearate, zinc palmitate, copper palmitate, or zinc linolenate, and fluorine resin such as polytetrafluoroethylene, polychlorotrifluoroethylene, polyvinylidene fluoride, polytrifluorochloroethylene, dichlorodifluoroethylene, tetrafluoroethylene-ethylene copolymer, or tetrafluoroethylene-hexafluoropropylene copolymer. The solid lubricant 17b is more preferably made of metallic stearate or zinc stearate that can effectively reduce friction of the photosensitive element 5.

By applying the lubricant to the surface of the photosensitive element 5 to form coating of the lubricant on the photosensitive element 5, a coefficient of friction of the photosensitive element 5 can be reduced to 0.4 or smaller. The coefficient of friction of the photosensitive element 5 is preferably set to 0.4 or smaller, and more preferably set to 0.2 or smaller. When the coefficient of friction is set 0.4 or smaller, interaction between the photosensitive element 5 and toner is reduced, so that adherence of the toner to the photosensitive element 5 can be reduced, improving transferability. Furthermore, increase in friction between the cleaning blade 15a and the photosensitive element 5 can be suppressed, resulting in improving a cleaning performance. More particularly, toner containing particles having high circularity can smoothly slide on the photosensitive element 5, so that occurrence of a cleaning failure can be suppressed. Furthermore, the amount of toner to be removed can be reduced because the transferability can be improved, so that occurrence of a cleaning failure due to long-term use can be suppressed. The above effects can be more effectively obtained when the coefficient of friction is set 0.2 or smaller. On the other hand, when the coefficient of friction is set smaller than 0.1, toner slides excessively in a space between the cleaning blade 15a and the photosensitive element 5, so that the cleaning blade 15a cannot catch some of the toner, leading to a cleaning failure.

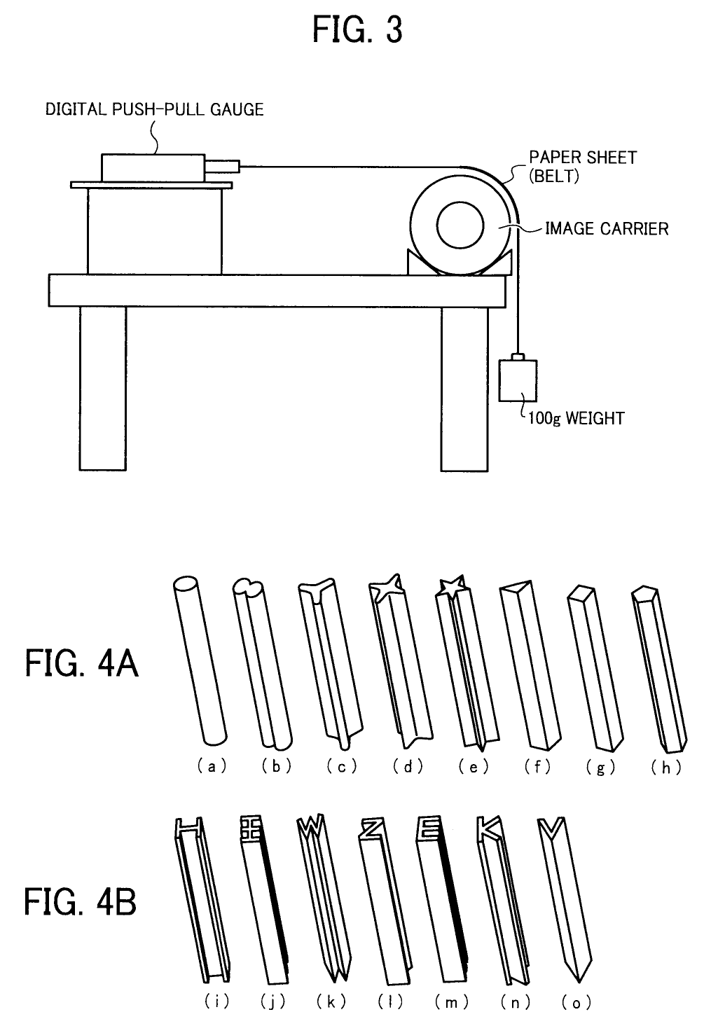

The coefficient of friction of the photosensitive element 5 is measured by the Euler-belt method as described below. FIG. 3 is a schematic diagram for explaining a method of measuring the coefficient of friction of the photosensitive element 5. In this example, a high-quality paper sheet having a medium thickness is used as a belt and is extended over one-fourth of a peripheral length of the photosensitive element in a state where a machine direction of the sheet coincides with a longitudinal direction of the photosensitive element. A weight of, for example, 0.98 Newtons, that is, 100 grams, is hung on one end of the belt and a force gauge is connected to the other end of the belt. When the force gauge is pulled and the belt is moved, a weight at this time is measured and then a coefficient of friction is calculated by the following Equation.

μₛ=2/π×ln(F/0.98)

where μₛ is a static coefficient of friction and F is a measured value (measured weight).

In the present embodiment, the coefficient of friction of the photosensitive element 5 is a value obtained after the image forming apparatus became a steady state through image forming processes. Specifically, the coefficient of friction of the photosensitive element 5 fluctuates from a coefficient of friction obtained just after starting the image forming process due to the influence of other devices in the image forming apparatus. However, after forming an image on about 1000 A4 sheets, the coefficient of friction becomes substantially constant. In the present embodiment, such a constant coefficient of friction in the steady state is employed as the coefficient of friction of the photosensitive element 5.

The applying unit 17 that applies the lubricant to the photosensitive element 5 is described in detail below with reference to FIG. 2. The solid lubricant 17b can be formed by melting and molding metal salts of fatty acids such as zinc stearate into a bar, or by molding fluorine resin such as polytetrafluoroethylene into a bar or a sheet. The solid lubricant 17b is mounted on a holding unit (not shown) and brought into contact with the brush roller 17a. The amount of the lubricant to be applied to the photosensitive element 5 can be adjusted by the spring 17d. Accordingly, life of the solid lubricant 17b can be made longer.

The brush roller 17a can be made of polystyrene, acrylic resin, ester resin, fluorine resin, amide resin, polyethylene terephthalate (PET) resin, or the like. It is more preferable to form the brush roller 17a by using amide resin having high abrasion resistance and high strength, or PET resin having less permanent deformation and causing less bristle deformation. The brush of the brush roller 17a can contain conductive powder. The conductive powder can be carbon black such as acetylene black or furnace black, black lead, metallic powder such as copper or silver, or the like. In this case, the brush roller 17a needs to be either conductive or semi-conductive. More particularly, electrical resistivity of the brush roller 17a needs to be set in a range from 10^{×2} Ω·cm to 10^{×8} Ω·cm. If the brush roller 17a is non-conductive, the brush roller 17a cannot apply bias voltage, or charge decay can hardly occur when the brush roller 17a is charged due to sliding or abutment with the photosensitive element 5 or the toner. The brush roller 17a is preferably grounded to prevent it from being charged. The brush roller 17a can apply a bias voltage obtained by superimposing an alternating-current voltage on a direct-current voltage.

With the increase of the pressing force of the spring 17d to press the solid lubricant 17b towards the brush roller 17a, the brush roller 17a scrapes off more amount of the lubricant, so that the amount of the lubricant to be applied to the photosensitive element 5 increases. As a result, the coefficient of friction of the photosensitive element 5 can be more reduced. As shown in FIG. 4B, a cross section of a bristle of the brush roller 17a is formed into an H shape ((i) in FIG. 4B), a double-H shape ((j) in FIG. 4B), a W shape (or an M shape, (k) in FIG. 4B), a Z shape (or an N shape, (l) in FIG. 4B), an E shape ((m) in FIG. 4B), a K shape ((n) in FIG. 4B), or a V shape ((o) in FIG. 4B). In other words, the brush roller 17a has bristles the cross section of each of which is shaped to include a vertex on the outer periphery of the bristle. More specifically, the brush roller 17a has bristles the cross section of each of which is shaped such that a point from which a plurality of projections extends is positioned outside a center of the cross section of the bristle. The bristle having such a cross section can have strength larger than a bristle having a conventional cross section ((a) in FIG. 4A), a shape having two or more convex portions (for example, a figure-eight shape ((b) in FIG. 4A), a three-arm star shape ((c) in FIG. 4A), a cross shape ((d) in FIG. 4A)), or a star shape ((e) in FIG. 4A)), or a polygonal shape (for example, a triangular shape ((f) in FIG. 4A), a quadrilateral shape ((g) in FIG. 4A), or a pentagonal shape ((h) in FIG. 4A)). Therefore, the brush roller 17a can come into contact with and slide on the surface of the solid lubricant 17b with relatively large force, so that the brush roller 17a can scrape more amount of the lubricant. Accordingly, weight of the spring 17d that presses the solid lubricant 17b towards the brush roller 17a can be set small.

As the weight of the spring 17d is set smaller, the eaten amount by the brush roller 17a to the solid lubricant 17b can be reduced, reducing rotational load on the brush roller 17a. As a result, life of a driving unit (not shown) can be made longer. Furthermore, torque of a motor (not shown) can be decreased, resulting in saving power consumption. Moreover, a driving operation can be stabilized, resulting in enhancing banding tolerance.

The brush roller 17a is caused to rotate in a direction same as the rotational direction of the photosensitive element 5 in a contact area. By rotating the brush roller 17a in the same direction, the brush roller 17a can apply the lubricant to the photosensitive element 5 without any impact on the photosensitive element 5. It is not necessary to form coating of the lubricant while the brush roller 17a applies the lubricant to the photosensitive element 5 because the lubricant applied to the photosensitive element 5 can be spread as the coating on the photosensitive element 5 by the pressing force of the cleaning blade 15a. Therefore, it is preferable to rotate the brush roller 17a in the same direction so that the lubricant can be applied without any impact on to the photosensitive element 5. A ratio of the circumferential velocity of the photosensitive element 5 to the circumferential velocity of the brush roller 17a is preferably set in a range from 0.8 to 1.2. If the ratio is set smaller than 0.8, the amount of the lubricant to be applied is too small. On the other hand, if the ratio is set larger than 1.2, the photosensitive element 5 may be damaged by the impact applied when the lubricant is applied thereto, resulting in shortening life of the photosensitive element 5. It is more preferable to set the ratio in the range from 1.0 to 1.1 so that the brush roller 17a can apply the lubricant to the photosensitive element 5 with little impact.

A process cartridge integrally accommodates the photosensitive element 5 on which a latent image is formed, the applying unit 17 that applies the lubricant to the photosensitive element 5, and at least one of the charging unit 14, the developing unit (one of the developing units 10A, 10B, 10C, and 10D), and the cleaning unit 15. The process cartridge is detachable from the image forming apparatus. In the process cartridge, the applying unit 17 includes the brush roller 17a that scrapes the solid lubricant 17b that is shaped into a bar and applies the scraped portion of the solid lubricant 17b to the photosensitive element 5. The toner used in the image forming apparatus is coated with lubricant and that lubricant can be applied to the photosensitive element 5. With this configuration, life of the photosensitive element 5 accommodated in the process cartridge can be made longer. Furthermore, if maintenance of the process cartridge is required, the process cartridge can be easily replaced with new one, which enhances usability.

According to one aspect of the present invention, life of a driving unit of the brush roller can be made longer, power consumption of a motor for the brush roller can be reduced and cost for driving the motor can be reduced by reducing torque of the motor, and banding tolerance due to rotational oscillation of the brush roller can be improved.

According to another aspect of the present invention, stable cleaning performance can be assured.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A brush roller that scrapes a lubricant and applies scraped lubricant to an image carrier, the brush roller comprising a bristle of which cross section is shaped such that a point from which a plurality of projections extends is positioned outside a center of the cross section of the bristle.

2. An image forming apparatus comprising:
an image carrier on which a toner image is formed;
a cleaning unit that removes residual toner remaining on the image carrier after transferring the toner image on the image carrier onto a medium; and
a lubricant applying unit that includes a lubricant and a brush roller that scrapes the lubricant and applies scraped lubricant to the image carrier, and that is arranged upstream of the cleaning unit in a rotation direction of the image carrier, wherein
the brush roller includes a bristle of which cross section is shaped such that a point from which a plurality of projections extends is positioned outside a center of the cross section of the bristle.

3. The image forming apparatus according to claim 2, wherein the image carrier has a coefficient of friction of 0.4 or smaller.

4. The image forming apparatus according to claim 2, wherein the lubricant is made of metal salts of fatty acids.

5. The image forming apparatus according to claim 2, wherein a ratio of a rotation frequency of the brush roller to a rotation frequency of the image carrier is set in a range from 0.8 to 1.2.

6. A process cartridge that is detachable from an image forming apparatus, the process cartridge comprising:
an image carrier on which a latent image is formed;
at least one of a charging unit that charges the image carrier, a developing unit that develops the latent image on the image carrier into a toner image with toner, and a cleaning unit that removes residual toner remaining on the image carrier after transferring the toner image on the image carrier onto a medium; and
a lubricant applying unit that includes a lubricant and a brush roller that scrapes the lubricant and applies scraped lubricant to the image carrier, and that is arranged upstream of the cleaning unit in a rotation direction of the image carrier.
